(19) United States
(12) Patent Application Publication
(10) Pub. No.: US 2018/0159989 A1
(43) Pub. Date: Jun. 7, 2018

(54) IMAGE FORMING APPARATUS AND CONTROL METHOD OF IMAGE FORMING APPARATUS

(71) Applicant: CANON KABUSHIKI KAISHA, Tokyo (JP)

(72) Inventor: Yoshitake Mizuno, Toride-shi (JP)

(21) Appl. No.: 15/831,185

(22) Filed: Dec. 4, 2017

(30) Foreign Application Priority Data
Dec. 7, 2016 (JP) 2016-237702

(51) Int. Cl. H04N 1/00; G03G 15/00; H04N 1/203

(52) U.S. Cl. CPC H04N 1/00082; G03G 15/5029; G03G 15/6567; H04N 2201/04743; H04N 1/00018; H04N 1/00034; H04N 1/2032; H04N 1/00005

(57) ABSTRACT

An image forming apparatus includes a reading unit, an image processing unit configured to perform image processing based on an adjustment condition, an image forming unit configured to form an image on a sheet based on image data on which the image processing is performed, and a controller configured to control the image forming unit to form a first measurement image on a first side of a sheet, control the image forming unit to form a second measurement image on a second side of the sheet, control the reading unit to obtain reading data related to the sheet on which the first and the second measurement images are formed, and generate the adjustment condition based on the reading data and a correction condition, wherein the controller generates the correction condition based on a reading result of the first side and a reading result of the second side.

### BACKGROUND

### Field of the Disclosure

The present disclosure relates to an image forming apparatus such as a copying machine and a printer, and more particularly to a technique for adjusting an image forming position with respect to a sheet.

### Description of the Related Art

When an image forming apparatus forms an image on a sheet, the image may sometimes be formed in a position different from an ideal forming position of the image. This will be referred to as a “positional deviation”. Japanese Patent Application Laid-Open No. 2003-173109 discusses an image forming apparatus which forms marks at predetermined positions on both sides of a sheet, reads the marks by a reading device, measures distances between sheet ends and the marks from the reading result, and adjusts forming positions of an image according to the measured distances.

A positional deviation can be caused by various factors. For example, a positional deviation can be caused by a sheet size, grammage, and a sheet conveyance mechanism. In any case, the amount of positional deviation can be measured by the reading device reading reference images for detecting the position of an image formed on a sheet. The image forming apparatus forms an image on an ideal position on a sheet by correcting the forming position of the image according to the amount of positional deviation. However, if a reading error (measurement error) occurs in the reading result of the reference images due to individual differences of the reading device, the image forming position fails to be accurately corrected.

For example, there is a case where some reading devices that scan an A3 size sheet to read an image employ wire take-up driving for scanning. A reading head of such a reading device may move as slightly tilted with respect to the scanning direction due to eccentricity of pulleys and warpage of scanning rails used for the wire take-up driving. As a result, the read scan image is tilted to cause reading errors, and the correction accuracy of the image forming position drops.

### SUMMARY

According to an aspect of the present disclosure, an image forming apparatus includes a reading unit including a carriage configured to move in a predetermined direction and irradiate an original, the reading unit being configured to read the original to generate image data on the original, an image processing unit configured to perform image processing to the image data based on an adjustment condition for adjusting an image forming position of an image to be formed on a sheet, an image forming unit configured to form the image on the sheet based on the image data on which the image processing is performed by the image processing unit, and a controller configured to control the image forming unit to form a first measurement image on a first side of a sheet, control the image forming unit to form a second measurement image on a second side of the sheet, the second side being different from the first side, control the reading unit to obtain reading data related to the sheet on which the first measurement image and the second measurement image are formed, and generate the adjustment condition based on the reading data and a correction condition, wherein the controller generates the correction condition based on a reading result of the first side of the sheet and a reading result of the second side of the sheet, the first measurement image being formed on the first side, the second measurement image being formed on the second side.

Further features of the present disclosure will become apparent from the following description of exemplary embodiments with reference to the attached drawings.

### BRIEF DESCRIPTION OF THE DRAWINGS

FIG. 1 is a schematic sectional view of an image forming apparatus according to one or more aspects of the present disclosure.

FIG. 2A is a hardware configuration diagram of a control unit according to one or more aspects of the present disclosure.

FIG. 2B is a functional block diagram of the image forming apparatus according to one or more aspects of the present disclosure.

FIG. 3 is a schematic diagram illustrating a selection screen according to one or more aspects of the present disclosure.

FIG. 4 is a schematic diagram illustrating a sheet management table according to one or more aspects of the present disclosure.

FIG. 5 is a schematic diagram illustrating a measurement chart according to one or more aspects of the present disclosure.

FIG. 6 is a calculation table for deriving amounts of positional deviation according to one or more aspects of the present disclosure.

FIG. 7 is an input screen of measurement results for a manual mode according to one or more aspects of the present disclosure.

FIG. 8 illustrates read images of the measurement chart according to one or more aspects of the present disclosure.

FIG. 9 is a schematic diagram for describing a reading error of squareness according to one or more aspects of the present disclosure.

FIG. 10 is a schematic diagram for describing a method for deriving individual differences of an image scanner according to one or more aspects of the present disclosure.

FIG. 11 is an explanatory diagram illustrating processing for correcting an image forming position according to one or more aspects of the present disclosure.

FIG. 12 is a flowchart illustrating for generating an adjustment condition in an automatic mode according to one or more aspects of the present disclosure.

FIG. 13 is a flowchart illustrating processing for reading the measurement chart according to one or more aspects of the present disclosure.

FIG. 14 is a flowchart illustrating image formation processing according to one or more aspects of the present disclosure.

### DESCRIPTION OF THE EMBODIMENTS

An exemplary embodiment will be described in detail below with reference to the drawings.

### (Configuration)

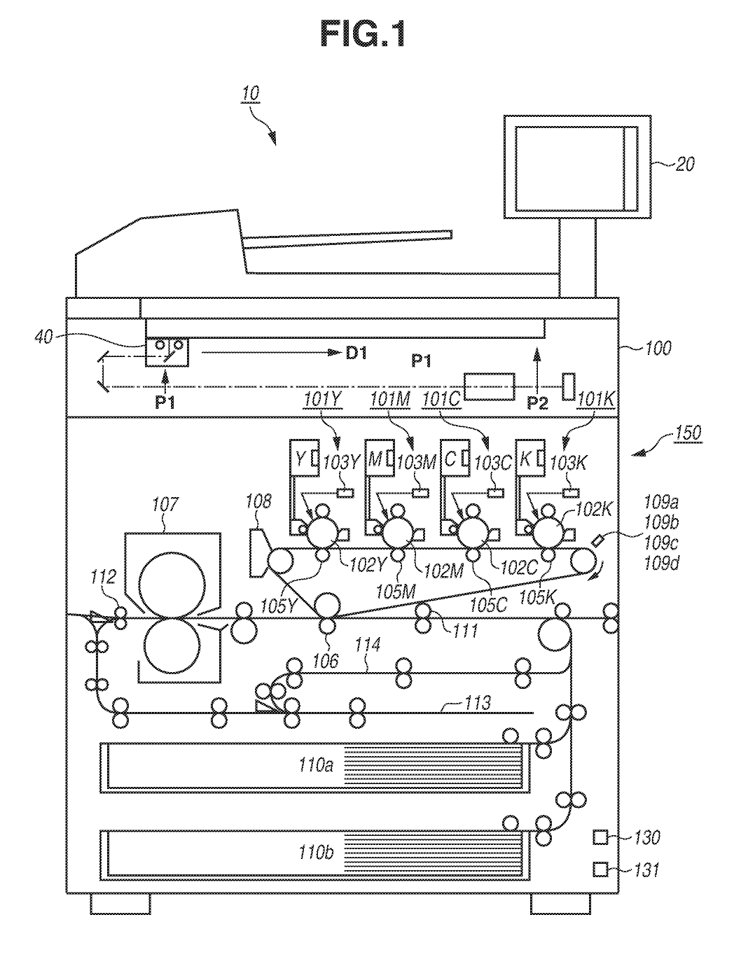

FIG. 1 is a schematic sectional view of an image forming apparatus according to the present exemplary embodiment. An image forming apparatus 10 includes a printer engine 150, an image scanner 100, and an operation unit 20. The printer engine 150 forms an image on a sheet. The printer engine 150 may be one for forming a monochrome image, whereas a configuration for forming a multicolor image will be described here. The image scanner 100 functions as a reading device for reading an image formed on a sheet and a measurement device for measuring an image forming position on the sheet from the read image. The operation unit 20 is a user interface and includes various types of operation buttons, a display device, and a touch panel. If an instruction to copy an image of an original is given from the operation unit 20, the image forming apparatus 10 reads an image from the original by using the image scanner 100. The image scanner 100 includes a reading unit 40 for reading an image from an original placed on a positioning plate. An example of the reading unit 40 is an optical sensor, which reads an original image by using reflected light resulting from irradiation of the original. The reading unit 40 can move from a home position P1 to an end position P2 in the direction of the arrow D1. The image scanner 100 generates image data expressing the read original image, and transmits the generated image data to the printer engine 150. The printer engine 150 performs image formation processing based on the obtained image data.

The printer engine 150 includes a plurality of image forming units 101Y, 101M, 101C, and 101K. The image forming units 101Y, 101M, 101C, and 101K form toner images by using toner of respective different colors. The image forming unit 101Y forms a yellow (Y) toner image. The image forming unit 101M forms a magenta (M) toner image. The image forming unit 101C forms a cyan (C) toner image. The image forming unit 101K forms a black (K) toner image. The symbols Y, M, C, and K attached to the ends of the reference numerals indicate the colors. When items common to all the colors are described, the symbols Y, M, C, and K will be omitted. The printer engine 150 may obtain image data from an information processing apparatus such as a not-illustrated personal computer, aside from the image scanner 100.

The image forming units 101 each include a photosensitive drum 102, an exposure device 103, a charging device, and a developing device. The photosensitive drum 102 is a drum-shaped image bearing member which rotates counterclockwise in the diagram. A surface of the photosensitive drum 102 is uniformly charged by the charging device. The exposure device 103 irradiates the photosensitive drum 102 with laser light based on the image data. An electrostatic latent image based on the image data is thereby formed on the photosensitive drum 102. The developing device develops the electrostatic latent image formed on the photosensitive drum 102. The developing device contains a two-component developer including toner and a carrier. The developing device supplies the toner to the photosensitive drum 102, whereby the electrostatic latent image is visualized. A yellow toner image is formed on the photosensitive drum 102Y. A magenta toner image is formed on the photosensitive drum 102M. A cyan toner image is formed on the photosensitive drum 102C. A black toner image is formed on the photosensitive drum 102K.

The printer engine 150 includes primary transfer devices 105Y, 105M, 105C, and 105K and an intermediate transfer belt 104 under the image forming units 101Y, 101M, 101C, and 101K. The primary transfer devices 105Y, 105M, 105C, and 105K transfer the toner images formed on the respective photosensitive drums 102Y, 102M, 102C, and 102K onto the intermediate transfer belt 104. A multicolor image is thereby formed on the intermediate transfer belt 104. The intermediate transfer belt 104 is an image bearing member for bearing an image. The intermediate transfer belt 104 rotates clockwise in the diagram, and conveys the formed toner image to a secondary transfer portion 106 by the rotation. A sheet is conveyed to the secondary transfer portion 106 in synchronization with the timing when the intermediate transfer belt 104 conveys the toner image to the secondary transfer portion 106.

Sheets are stored in storage units 110a and 110b provided in the printer engine 150. The sheets stored in the storage units 110a and 110b are fed by sheet feeding rollers one by one. The fed sheet is conveyed through a conveyance path to registration rollers 111. The registration rollers 111 correct a skew of the sheet. The registration rollers 111 convey the sheet to the secondary transfer portion 106 in synchronization with the timing when the toner image on the intermediate transfer belt 104 is conveyed to the secondary transfer portion 106. When the toner image on the intermediate transfer belt 104 and the sheet pass through the secondary transfer portion 106, the toner image is transferred from the intermediate transfer belt 104 onto the sheet. After the transfer, toner remaining on the intermediate transfer belt 104 is cleaned by a belt cleaner 108.

The printer engine 150 includes a fixing device 107. The sheet onto which the toner image is transferred is conveyed from the secondary transfer portion 106 to the fixing device 107. The fixing device 107 includes a plurality of rollers and a heater. The fixing device 107 applies heat and pressure to the unfixed toner image transferred onto the sheet by using the rollers and the heater, whereby the toner image is fixed to the sheet. The image formation on the sheet is thereby finished. The sheet on which the image formation is finished is discharged from the fixing device 107 to outside the printer engine 150 (image forming apparatus 10) by discharge rollers 112. The sensors 109a, 109b, 109c, and 109d each measure an amount of toner of a measurement image. The sensors 130, and 131 detect temperature and humidity.

In performing two-sided printing, a sheet on a first side (front) of which an image is formed is passed through the fixing device 107 and then conveyed to a reverse path 113 by a flapper. The conveyance direction of the sheet is reversed in the reverse path 113, and the sheet is conveyed to a two-sided path 114. The conveyance from the reverse path 113 to the two-sided path 114 reverses the front and back of the sheet. The reversed sheet is conveyed to the registration rollers 111 again via the two-sided path 114, and image formation is performed on a second side (back) different from the first side in a similar manner to on the first side. The sheet is then discharged out of the printer engine 150 (image forming apparatus 10) by the discharge rollers 112. The image forming apparatus 10 thus forms output images on the sheet.

One of image quality factors during two-sided printing is that an image forming position of the output image on the front and that of the output image on the back are well aligned. The image forming positions on the front and back are checked by using a measurement chart. The measurement chart is a sheet on which measurement images for measuring an image forming position are formed. The image forming positions on the front and back are measured by using a measurement chart, or sheet, on both sides of which the measurement images are formed. According to the measurement results of the image forming positions on the front and back, amounts of deviation (amounts of positional deviation) of the image forming positions on both sides are corrected to align the image forming positions on the front and back.

### (Control Unit)

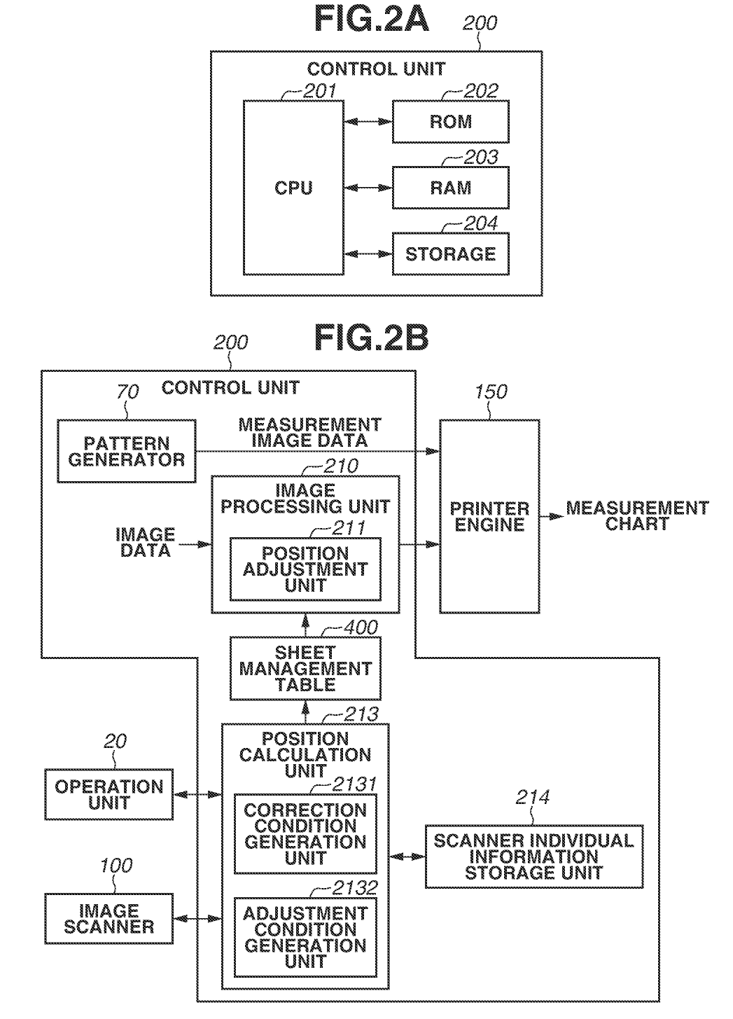

FIGS. 2A and 2B are configuration diagrams of a control unit for controlling an operation of the image forming apparatus 10 having such a configuration. A control unit 200 is built in the image forming apparatus 10. FIG. 2A is a hardware configuration diagram of the control unit 200. The control unit 200 includes a central processing unit (CPU) 201, a read-only memory (ROM) 202, a random access memory (RAM) 203, and a storage 204.

The CPU 201 reads computer programs from the ROM 203 and the storage 204, executes the computer programs by using the RAM 203 as a work area, and thereby controls the operation of the image forming apparatus 10. The storage 204 is a mass storage device such as a hard disk drive (HDD) and a solid state drive (SSD). The storage 204 stores image data obtained from the image scanner 100 and an external information processing apparatus, and various types of setting information input from the operation unit 20. In particular, in the present exemplary embodiment, the storage 204 stores an adjustment condition for correcting the image forming positions.

FIG. 2B is a functional block diagram of the image forming apparatus 10. In the present exemplary embodiment, functions for correcting the image forming positions will be described. A description of image forming functions of the image forming apparatus 10 will be omitted. The CPU 201 executes the computer programs, whereby the control unit 200 functions as an image processing unit 210, a position calculation unit 213, a scanner individual information storage unit 214, a sheet management table 400, and a pattern generator 70. The functions of the control unit 200 may be implemented by discrete parts or a one-chip semiconductor product, instead of being implemented by the execution of the computer programs. Examples of the one-chip semiconductor product include a micro-processing unit (MPU), an application specific integrated circuit (ASIC), and a system on a chip (SOC).

The image processing unit 210 includes a position adjustment unit 211. The image processing unit 210 performs various types of image processing on image data and corrects the image data so that a desired image is formed on a sheet. Examples of the image processing performed by the image processing unit 210 include processing for tone correction and for correction of the image forming positions. The image data corrected by the image processing unit 210 is transmitted to the exposure devices 103 of the printer engine 150. The exposure devices 103 irradiate the photosensitive drums 102 with laser light modulated based on the image data corrected by the image processing unit 210, whereby electrostatic latent images based on the image data are formed on the photosensitive drums 102.

The position adjustment unit 211 corrects the forming position of an image on a sheet based on the adjustment condition. The position adjustment unit 211 corrects the image data by a known method so that the image forming position on the sheet comes to a target position.

The image forming position of the image formed on the sheet may fail to coincide with an ideal image forming position. For example, if the sheet passes through the secondary transfer position 106 with a skew with respect to the conveyance direction, the image is formed obliquely to the sheet. If the rollers of the fixing device 107 do not have a uniform pressure distribution, the sheet under the fixing processing is deformed and the image is formed obliquely to the sheet. If two-sided printing is performed, the sheet expands or contracts due to the heat and pressure in the fixing device 107 during the image formation on the front, and the image formed on the front and the image formed on the back have different sizes (two-sided magnification error). In such a case, the image forming position on the front of the sheet becomes different from that on the back.

The skew of the sheet passing through the secondary transfer portion 106 and the amount of deformation of the sheet in the fixing device 107 have high reproducibility if the size, grammage, and material of the sheet are the same. The image forming apparatus 10 of the present exemplary embodiment deforms the shape of the image to be formed according to the amount of deformation of the sheet so that the image forming position on the sheet comes to the ideal position. The position adjustment unit 211 converts the image data based on an adjustment condition such as a conversion formula for correcting a deviation of the image forming position with respect to the sheet. The adjustment condition is stored in the sheet management table 400. For example, if the magnification in a main scanning direction of the sheet is 1.1 times, the position adjustment unit 211 corrects the image data so that the image to be formed has a length 1/1.1 times in the main scanning direction. As a result, the image formed on the sheet has a magnification of 1.0 time in the main scanning direction. If the coordinates of a predetermined pixel deviate by 0.1 pixels in a predetermined direction, the position adjustment unit 211 corrects the image data to shift the coordinates of the pixel by 0.1 pixels in the opposite direction. As a result, the pixel is formed at the ideal position of the sheet. The image forming unit 101 forms an image based on the image data converted by the position adjustment unit 211. In such a manner, an image in which a deviation of the image forming position with respect to the sheet is cancelled out is formed on the intermediate transfer belt 104. The sheet management table 400 stores amounts of positional deviation of the image forming position and an adjustment condition for suppressing the amounts of positional deviation, generated by the position calculation unit 213, with respect to each sheet type. For example, the sheet management table 400 is formed in the storage 204.

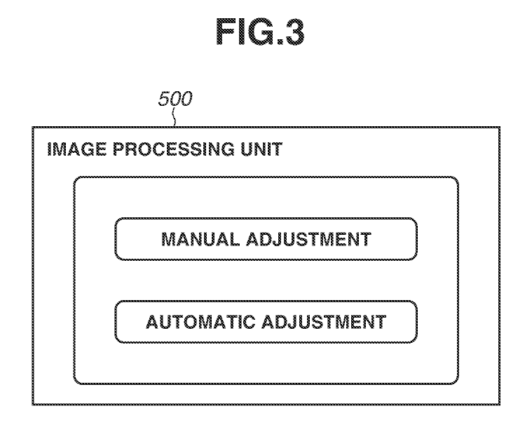

The position calculation unit 213 measures the amounts of positional deviation of the image forming position, and generates a correction condition and an adjustment condition. For that purpose, the position calculation unit 213 includes a correction condition generation unit 2131 and an adjustment condition generation unit 2132. The position calculation unit 213 measures the amounts of positional deviation of the image forming position in either one of adjustment condition generation modes including a manual mode and an automatic mode. The adjustment condition generation mode is selected by using the operation unit 20. FIG. 3 is a diagram illustrating an example of a selection screen for selecting the adjustment condition generation mode. For example, a selection screen 500 is displayed on the operation unit 20 if an instruction to generate an adjustment condition for correcting the image forming position is input from the operation unit 20. The user selects either one of the manual and automatic modes from the selection screen 500 by using the operation unit 20. The position calculation unit 213 obtains the selection result from the operation unit 20, measures the amounts of positional deviation of the image forming position in the adjustment condition generation mode according to the selection result, and generates the adjustment condition for the measured amounts of positional deviation.

The pattern generator 70 transmits measurement image data, which is image data for forming measurement images for measuring the image forming position, to the printer engine 150. The printer engine 150 forms the measurement images on a sheet according to the measurement image data, whereby a measurement chart is generated.

In the manual mode, the user measures the positions of the measurement images formed on the measurement chart, and inputs the measurement results into the position calculation unit 213 from the operation unit 20. The position calculation unit 213 measures the amounts of positional deviation of the image forming position from the measurement results input from the operation unit 20, generates an adjustment condition for the amounts of positional deviation, and stores the generated adjustment condition into the sheet management table 400. In the automatic mode, the image scanner 100 reads the positions of the measurement images formed on the measurement chart, and inputs the reading result (read image) into the position calculation unit 213. The position calculation unit 213 measures the positions (coordinate data) of the measurement images from the read image, generates an adjustment condition, and stores the generated adjustment condition into the sheet management table 400.

The scanner individual information storage unit 214 stores a correction condition generated to reduce measurement errors in the image forming position due to individual differences of the image scanner 100. The position calculation unit 213 generates the correction condition based on the result of measurement of the measurement images by the image scanner 100. The position calculation unit 213 applies the correction condition to the measurement result of the measurement images obtained from the image scanner 100, whereby measurement errors included in the measurement result due to individual differences of the image scanner 100 are reduced. According to the measurement result of which the measurement errors are reduced, the position calculation unit 213 generates the adjustment condition for the amounts of positional deviation of the image forming position.

### (Sheet Management Table)

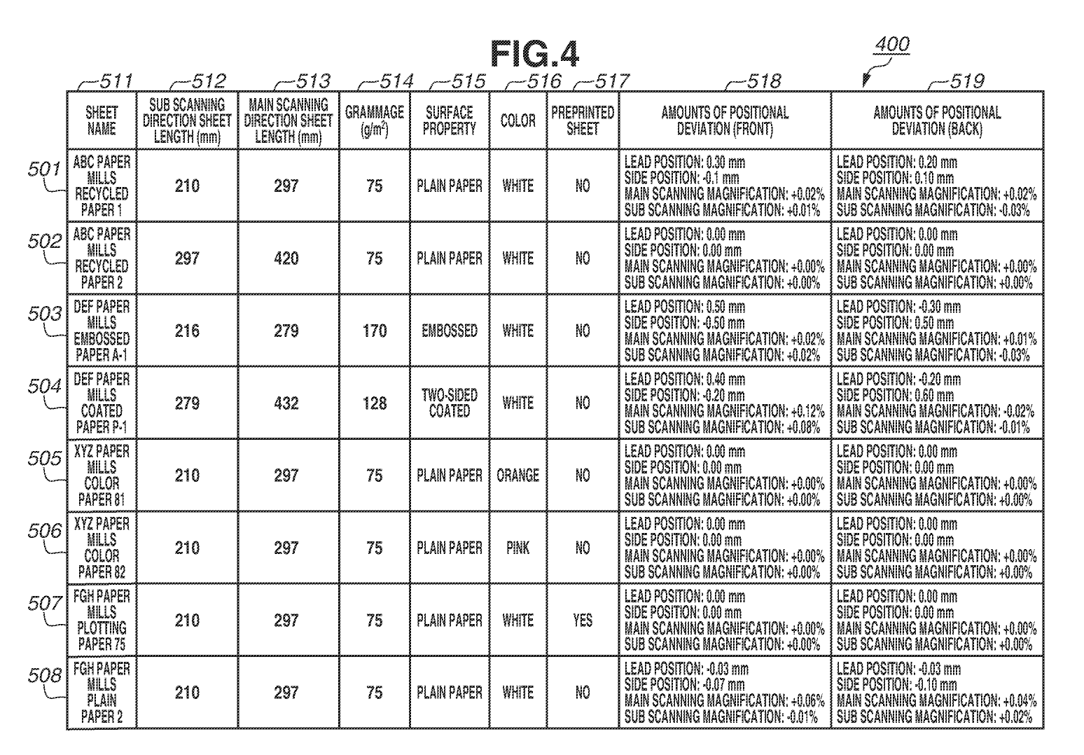

FIG. 4 is a diagram illustrating an example of the sheet management table 400. Examples of sheets managed by the sheet management table 400 include commercially available sheets evaluated by printer makers and sheets registered by the user from the operation unit 20. For example, the sheet management table 400 is stored in the storage 204 in a file format of an Extensible Markup Language (XML) file or a comma-separated values (CSV) file. The sheet management table 400 can be read, written, and updated as appropriate.

Attribute data on each sheet type is registered in the sheet management table 400. A sheet type is identified by a sheet name 511. The attribute data includes physical characteristics of the sheet, including a sub scanning direction sheet length 512 of the sheet, a main scanning direction sheet length 513 of the sheet, grammage 514 of the sheet, a surface property 515 of the sheet, and color 516 of the sheet. The attribute data also includes information 517 about whether the sheet is a preprinted sheet, amounts of positional deviation 518 on the front, and amounts of positional deviation 519 on the back. The surface property 515 of the sheet indicates a physical property of the sheet surface, such as plain paper, embossed, and two-sided coated. In general, coating is performed to improve glossiness of the sheet surface. Embossing is processing for forming raised or recessed portions on/in the sheet surface. The color 516 of the sheet indicates the color of the sheet. The information 517 about whether the sheet is a preprinted sheet indicates whether the sheet used in printing is a preprinted sheet. Examples of preprinted sheets include sheets on which ruled lines or frames are printed in advance.

The amounts of positional deviation 518 are values quantitatively expressing a positional deviation from an ideal image forming position on the front of the sheet. The amounts of positional deviation 519 are values quantitatively expressing a positional deviation from an ideal image forming position on the back of the sheet. The image forming positions on the sheet during image formation are corrected according to the amounts of positional deviation 518 and 519, whereby images are formed at the ideal image forming positions with respect to the sheet. The image forming apparatus 10 performs image formation by adjusting the image forming positions to cancel out the amounts of positional deviation 518 and 519. In the present exemplary embodiment, the amounts of positional deviation 518 and 519 are expressed in terms of a lead position, a side position, a main scanning magnification, and a sub scanning magnification.

The lead position indicates the amount of positional deviation of the image forming position in the sub scanning direction with respect to each sheet. The side position indicates the amount of positional deviation of the image forming position in the main scanning direction with respect to each sheet. The lead position refers to a formation start position of an image with the leading edge of the sheet in the conveyance direction as a start point. The lead position has an initial value of “0”. The side position refers to a formation start position of the image with a sheet end on the left side of the sheet seen in the conveyance direction as a start point. The side position has an initial value of “0”. For example, the lead position and the side position are adjusted by controlling irradiation start timing of the laser light with which the exposure devices 103 irradiate the photosensitive drums 102. The sub scanning magnification indicates a deviation of the image length in the sub scanning direction (magnification with respect to an ideal length). For example, the sub scanning magnification is adjusted by controlling the rotation speed of the intermediate transfer belt 104. The main scanning magnification indicates a deviation of the image length in the main scanning direction (magnification with respect to an ideal length). For example, the main scanning magnification is adjusted by controlling a clock frequency of the laser light when the exposure devices 103 modulate the laser light based on the image data. The sub scanning magnification and the main scanning magnification have an initial value of “0”.

As described above, the image forming apparatus 10 can operate in the two adjustment condition generation modes, namely, the manual mode and the automatic mode. In the manual mode, the user measures the measurement chart by using a ruler, and inputs the measurement results from the operation unit 20. The position calculation unit 213 derives the amounts of positional deviation 518 and 519 based on the input measurement results. In the automatic mode, the image scanner 100 reads the measurement chart. The position calculation unit 213 derives the amounts of positional deviation 518 and 519 based on the positions of the measurement images on the measurement chart. With the amounts of positional deviation 518 and 519 as attribute data on the sheet, the position calculation unit 213 registers new attribute data or updates previously-registered attribute data in the sheet management table 400.

### (Amounts of Positional Deviation)

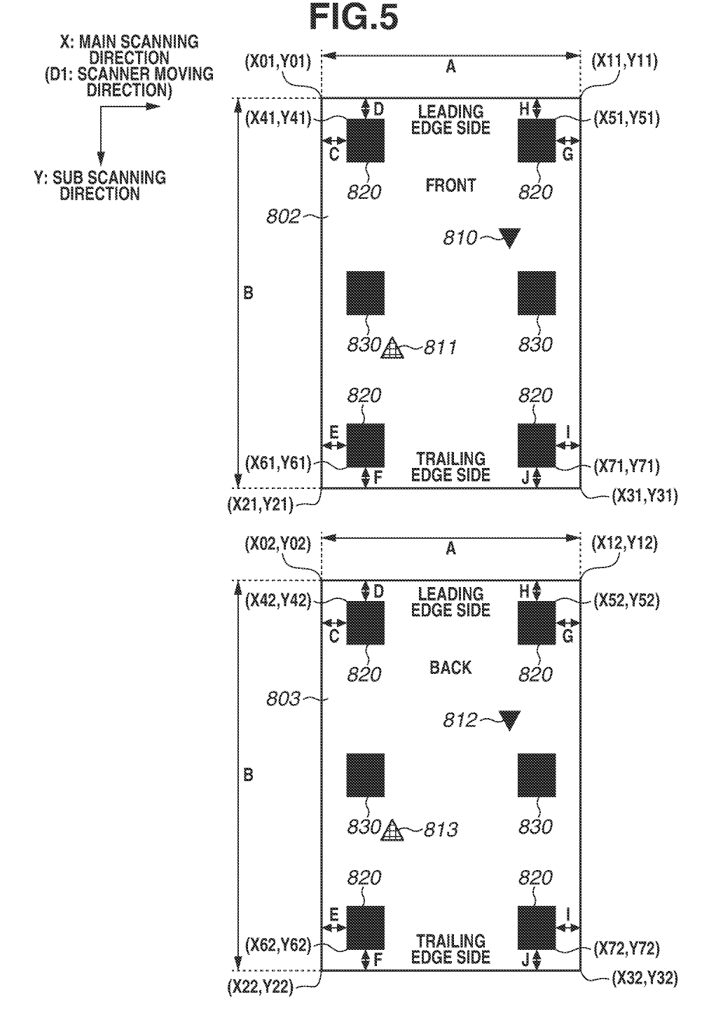

FIG. 5 is a schematic diagram illustrating the measurement chart. The measurement chart includes measurement images 820 formed at predetermined positions on a front 802 and a back 803 of the sheet. In the present exemplary embodiment, a total of eight measurement images 820 are formed at four corners of both sides of the measurement chart. If the measurement images 820 are formed at ideal positions, the measurement images 820 are formed at positions a predetermined distance from the sheet ends of the measurement chart. The measurement images 820 are formed in color having a large difference in reflectance from the color of the sheet. For example, black measurement images 820 are formed on a white sheet.

Since the measurement images 820 are formed in color having a large difference in reflectance from the color of the sheet, the distances of the measurement images 820 from the sheet ends can be accurately measured from the read images of the measurement chart read by the image scanner 100. In the manual mode, the user measures the distances from the sheet edges to the measurement images 820. The amounts of positional deviation 518 and 519 are derived according to the distances of the measurement images 820 from the sheet ends.

For example, the image scanner 100 reads each side of the measurement chart by two separate reading operations. In such a case, the measurement chart includes marks 830 for combining the read image of the first half and that of the second half. Two marks 830 are formed on each of the front 802 and back 803 of the measurement chart. The position calculation unit 213 combines the read images of the first and second halves so that center positions of the marks 830 in the read image of the first half coincides with those of the marks 830 in the read image of the second half. A read image of one sheet (measurement chart) is generated in such a manner.

The measurement chart includes marks 810, 811, 812, and 813 which serve as indexes for positioning when the measurement chart is read by the image scanner 100. The marks 810, 811, 812, and 813 are formed in respective different colors. For example, the mark 810 is blue, the mark 811 is yellow, the mark 812 is red, and the mark 813 is green. If the measurement chart is read by the image scanner 100, the colors of the marks 810, 811, 812, and 813 are specified on the operation unit 20 in order. The user makes the image scanner 100 read the measurement chart in the order of the colors specified. This prevents redundant reading of the measurement chart.

Such a measurement chart is formed to include the same measurement images 820 regardless of the adjustment condition generation mode. In view of ease of measurement, a measurement chart may be formed to include different measurement images 820 according to the adjustment condition generation mode. In such a case, a plurality of pieces of image data expressing different measurement images 820 is stored in the pattern generator 70. The image data is transmitted from the pattern generator 70 to the printer engine 150 as appropriate according to the adjustment condition generation mode input from the operation unit 20.

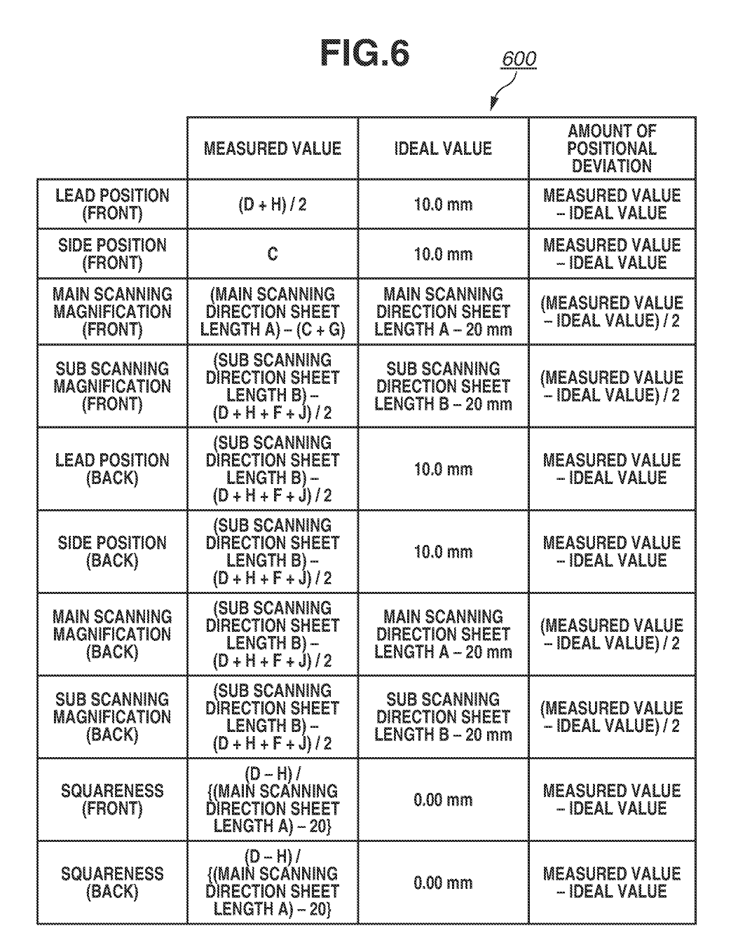

FIG. 6 is a calculation table for deriving the amounts of positional deviation 518 and 519 from the measurement results of the distances of the measurement images 820 from the sheet ends, read from the measurement chart. A calculation table 600 is stored in the storage 204. The control unit 200 calculates the amounts of positional deviation 518 and 519 based on the calculation table 600.

As described in FIG. 4, the amounts of positional deviation 518 and 519 are expressed in terms of items with respect to the front 802 and ones with respect to the back 803. The calculation table 600 shows conversion formulas for the amounts of positional deviation 518 and 519 with respect to the items on the front 802 and back 803. The items expressing the amounts of positional deviation 518 and 519 include squareness in addition to the foregoing lead positions, side positions, main scanning magnifications, and sub scanning magnifications. The squareness is defined by distances D and H (see FIG. 5) from the leading edge of the sheet to measurement images 820 and a sheet length A in the main scanning direction (see FIG. 5). The parameters A to J used in the conversion formulas of the items are the measurement results of the distances of the measurement images 820 from the sheet ends as illustrated in FIG. 5. An adjustment condition is generated to cancel out the amounts of positional deviation 518 and 519 calculated from such conversion formulas. In other words, the amounts of positional deviation 518 and 519 are parameters for defining the conversion formulas which are examples of the adjustment condition. In a broader sense, the amounts of positional deviation 518 and 519 themselves are an adjustment condition.

In the automatic mode, the image scanner 100 reads each side of the measurement chart by two separate reading operations (first half and second half). The reason is that the sheet ends of the measurement chart on the positioning plate need to be enhanced so that the position calculation unit 213 detects the sheet ends of the measurement chart by edge detection. For such enhancement, the measurement chart may be pressed against the positioning plate by using a black pressing plate.

In the first reading operation, the image scanner 100 reads the first half (the half on the leading edge side) of the front 802 of the measurement chart while moving the reading unit 40 from the home position P1 to the end position P2. In the second reading operation, the image scanner 100 reads the second half (the half on the trailing edge side) of the front 802 of the measurement chart while moving the reading unit 40 from the home position P1 to the end position P2. In the third reading operation, the image scanner 100 reads the first half (the half on the leading edge side) of the back 803 of the measurement chart while moving the reading unit 40 from the home position P1 to the end position P2. In the fourth reading operation, the image scanner 100 reads the second half (the half on the trailing edge side) of the back 803 of the measurement chart while moving the reading unit 40 from the home position P1 to the end position P2. The measurement images 820 on both sides of the measurement chart are read by such four reading operations.

The position calculation unit 213 combines the read images of the first and second halves of the front 802 of the measurement chart according to the positions of the marks 830. As illustrated in FIG. 5, the position calculation unit 213 obtains coordinates Pt01(X01, Y01) to Pt71(X71, Y71) from the combined read image. Similarly, the position calculation unit 213 combines the read images of the first and second halves of the back 803 of the measurement chart according to the positions of the marks 830. As illustrated in FIG. 5, the position calculation unit 213 obtains coordinates Pt02(X02, Y02) to Pt72(X72, Y72) from the combined read image. Coordinates are denoted as Ptij(Xij, Yij), where i is an identification number indicating a position, and j is an identification number indicating the front 802 (j=1) or the back 803 (j=2). The coordinates Pt01 refer to those of the upper left corner of the front 802 of the measurement chart (in the following description, the leading edge side of the measurement chart will be referred to as top, and the trailing edge side as bottom. The left and right refer to left and right directions when viewing toward the leading edge side). The coordinates Pt11 refer to those of the upper right corner of the front 802 of the measurement chart. The coordinates Pt21 refer to those of the lower left corner of the front 802 of the measurement chart. The coordinates Pt31 refer to those of the lower right corner of the front 802 of the measurement chart. The coordinates Pt41 refer to those of the upper left corner of the measurement image 820 formed on the upper left of the front 802. The coordinates Pt51 refer to those of the upper right corner of the measurement image 820 formed on the upper right of the front 802. The coordinates Pt61 refer to those of the lower left corner of the measurement image 820 formed on the lower left of the front 802. The coordinates Pt71 refer to those of the lower right corner of the measurement image 820 formed on the lower right of the front 802. The coordinates Pt02 to Pt72 on the back 803 are similarly defined.

In the automatic mode, the amounts of positional deviation 518 and 519 are measured from the read images of the measurement chart read by the image scanner 100. Individual differences of the image scanner 100 produce errors in the read images. In deriving the amounts of positional deviation 518 and 519, a correction condition for reducing reading errors is therefore needed. In the manual mode, the image scanner 100 is not needed. Processing for reducing reading errors due to individual differences of the image scanner 100 is therefore not needed.

### (Manual Mode)

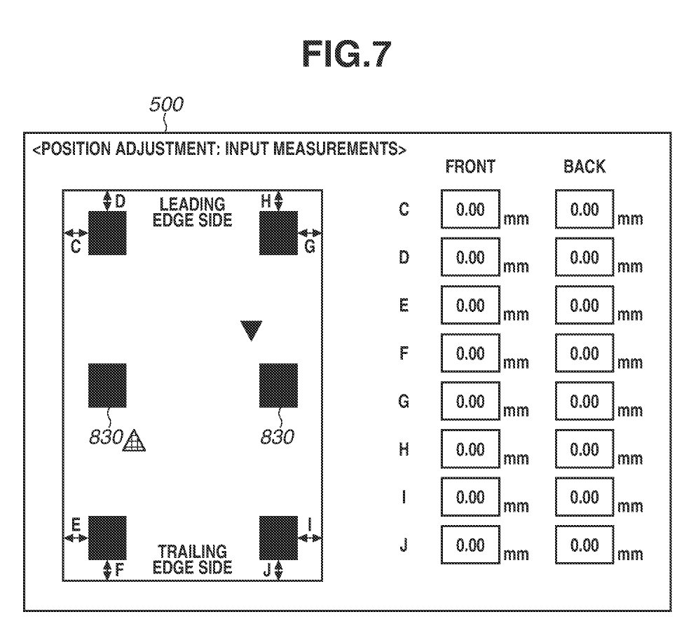

FIG. 7 illustrates an input screen of measurement results for the manual mode. An input screen 700 is displayed on the operation unit 20 when the manual mode is set. The input screen 700 includes guidance indicating portions to be measured of the measurement chart, and input boxes for inputting the measurement results. In this example, the user measures the parameters C to J on each of the front 802 and back 803 of the measurement chart, and inputs the measurement results to the corresponding input boxes by using the operation unit 20.

The position calculation unit 213 calculates the amounts of positional deviation 518 and 519 of the image forming positions by using the conversion formulas listed in the calculation table 600 of FIG. 6, based on the measurement results input from the input screen 700. The positon calculation unit 213 calculates the amounts of positional deviation of the “lead position”, “side position”, “main scanning magnification”, “sub scanning magnification”, and “squareness” on both sides of the measurement chart by substituting the measurement results into the calculation formulas (conversion formulas) registered in the calculation table 600. The position calculation unit 213 registers the calculated amounts of positional deviation of the respective items into the amounts of positional deviation 518 and 519 of the sheet management table 400 as attribute data on the sheet.

### (Automatic Mode)

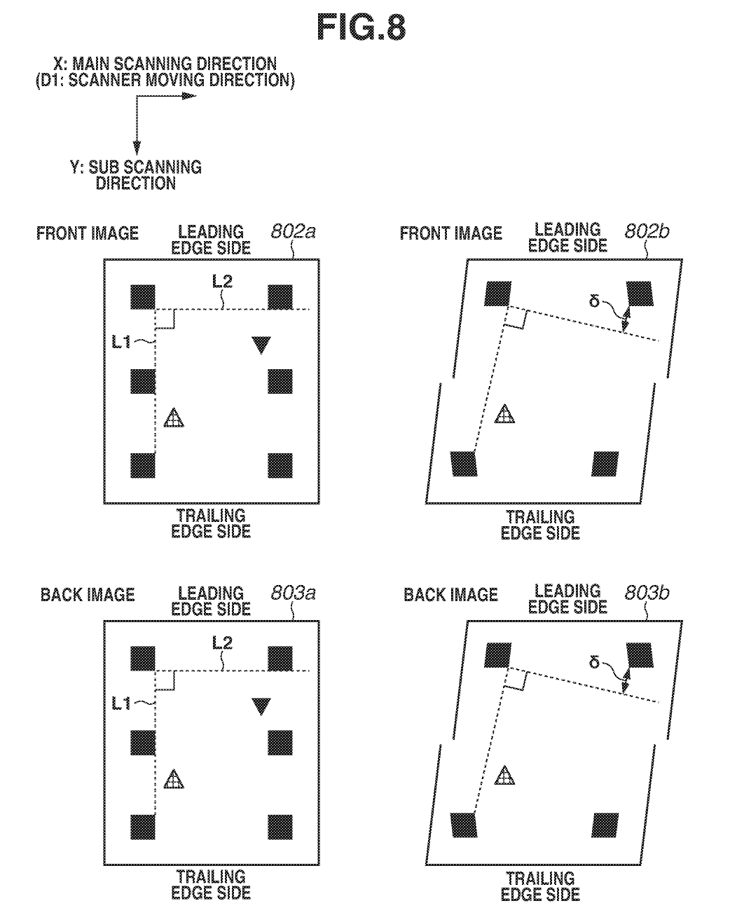

FIG. 8 is a schematic diagram illustrating read images corresponding to the results of reading of the measurement chart by the image scanner 100. Individual differences of the image scanner 100 will be described based on FIG. 8. The image forming apparatus 10 performs two-sided printing to output a measurement chart, or sheet, on both sides of which the measurement images 820 are formed. A front image 802a and a back image 803a represent the respective sides of the measurement chart on which the measurement images 820 are formed. The image forming apparatus 10 forms the measurement chart so that the measurement images 820 in both the front image 802a and the back image 803a are formed with correct squareness.

The image scanner 100 includes a scanning rail for moving the reading unit 40 from the home position P1 to the end position P2. A deviation in the flatness of the scanning rail, a distortion of the housing of the image scanner 100, and a focus error of the reading unit 40 can cause an error in the squareness of the read images of the measurement chart. Front images 802b and back images 803b represent the results of reading of the measurement chart by the image scanner 100. As described above, the image scanner 100 reads each side of the measurement chart in halves on the leading edge side and the trailing edge side separately. The front images 802b and the back images 802b are therefore obtained as read images divided in halves on the leading edge side and the trailing edge side. As illustrated by the front and back images 802b and 803b, the read images of the measurement chart read by the image scanner 100 have a squareness deviation δ. The squareness deviation δ is a reading error inherent to each individual image scanner 100, occurring due to part tolerances and assembly processes. The squareness deviation δ is one of correction conditions that are derived from the read images of the measurement chart by the position calculation unit 213 and stored in the scanner individual information storage unit 214.

The squareness deviation δ is expressed in units of distance. In the present exemplary embodiment, the squareness deviation δ is expressed by a distance between a line L2 and the lower left corner of the upper right measurement image 820 on the measurement chart. The line L2 is orthogonal to a line L1 connecting the lower right corner of the upper left measurement image 820 and the upper right corner of the lower left measurement image 820. Alternatively, the squareness deviation δ may be expressed by a distance between a line that is orthogonal to a line connecting the upper left corner of the upper left measurement image 820 and the lower left corner of the lower left measurement image 820 and the upper right corner of the upper right measurement image 820. The squareness deviation δ expresses the amount of positional deviation of the image forming position in the sub scanning direction of the measurement chart.

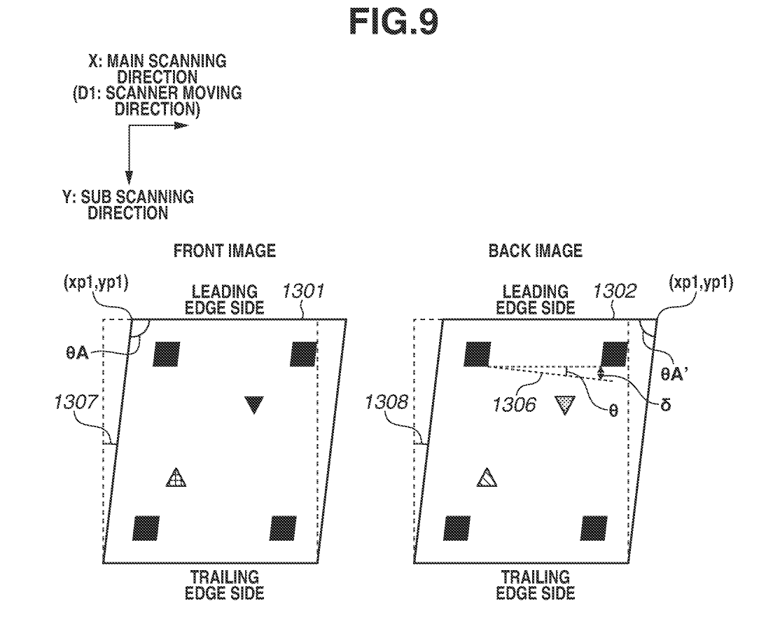

FIG. 9 is a schematic diagram for describing a reading error in squareness, occurring from individual differences of the image scanner 100. The read images of the measurement chart read by the image scanner 100 on the leading and trailing edge sides separately are combined by the position calculation unit 213 based on the marks 830. A front image 1301 is a read image obtained by combining the front images 802b of FIG. 8. A back image 1302 is a read image obtained by combining the back images 803b of FIG. 8. The measurement images 820 are formed on both sides (front 802 and back 803) of the measurement chart with correct squareness. Both sides (front 802 and back 803) of the measurement chart are placed and read on the positioning plate without skew with respect to the main scanning direction of the image scanner 100.

The upper left corner of the front image 1301 has coordinates (xp1, yp1) and an angle θA. The upper right corner of the back image 1302 corresponding to the upper left corner of the front image 1301 has an angle θA′. Due to a reading error in squareness, the front image 1301 is deformed from an ideal rectangular read image illustrated in broken lines. A degree of deformation 1307 is expressed by an error angle θ. The back image 1302 is similarly deformed, and a degree of deformation 1308 is expressed by the error angle θ which is the same angle as that of the degree of deformation 1307. The error angle θ is expressed by the following equation:

θ=(θA−θA′)/2. (Eq. 1)

The squareness deviation δ shifts a line 1306 that is orthogonal to a line connecting the lower right corner of the upper left measurement image 820 and the upper right corner of the lower left measurement image 820 of the back image 1302 as much as the error angle θ, compared to when there is no reading error.

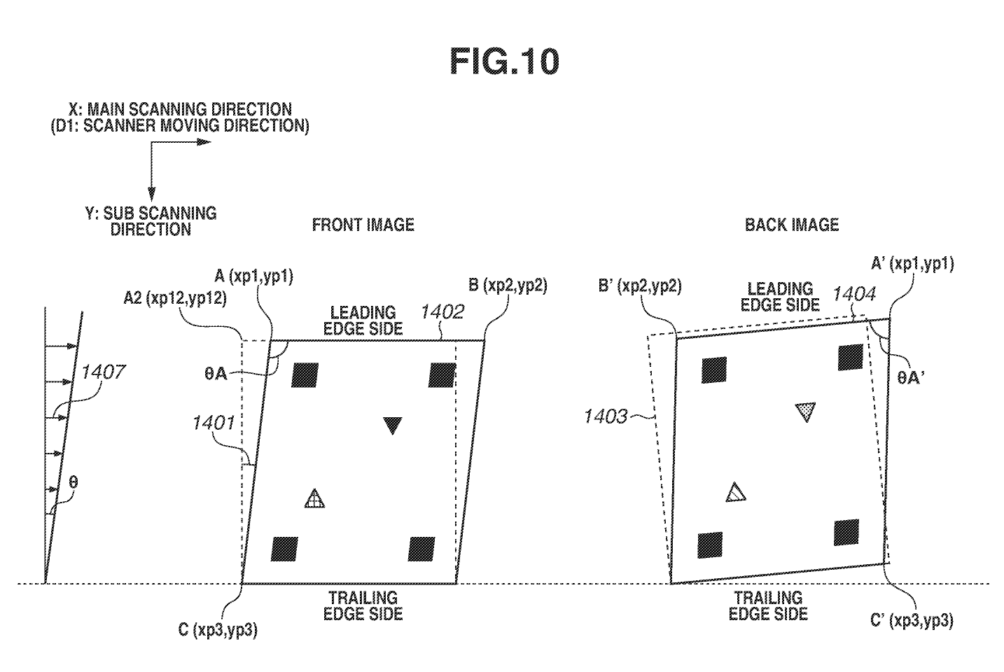

FIG. 10 is a schematic diagram for describing a method for deriving individual differences of the image scanner 100. Here, a method for deriving the squareness deviation δ will be described.

A front image 1402 is a read image obtained by combining the front images 802b of FIG. 8. The front image 1402 is read by placing the measurement chart on the positioning plate without skew with respect to the main scanning direction of the image scanner 100. Due to a reading error, the front image 1402 is deformed from an ideal rectangular read image 1401 illustrated in broken lines. The upper left corner of the front image 1402 has coordinates A(xp1, yp1) and an angle θA. The upper right corner of the front image 1402 has coordinates B(xp2, yp2). The lower left corner of the front image 1402 has coordinates C(xp3, yp3).

A back image 1404 is a read image obtained by combining the read images in the first and second halves of the back 803, read by placing the measurement chart on the positioning plate with a skew with respect to the main scanning direction of the image scanner 100. The upper right corner of the back image 1404 corresponding to the upper left corner of the front 802 of the measurement chart has coordinates A′(xp1, yp1) and an angle θA′. The upper left corner of the back image 1404 corresponding to the upper right corner of the front 802 of the measurement chart has coordinates B′(xp2, yp2). The lower right corner of the back image 1404 corresponding to the lower left corner of the front 802 of the measurement chart has coordinates C′(xp3, yp3). Due to a reading error, the back image 1404 is deformed from a read image 1403 which is read in the skewed state and illustrated in broken lines.

Since the back image 1404 is generated by reading the measurement chart that is placed on the positioning plate with a skew with respect to the main scanning direction of the image scanner 100, the error angle θ is not able to be calculated from (Eq. 1). The reason is that an amount of squareness deviation 1407 varies with the position in the sub scanning direction orthogonal to the main scamming direction of the image scanner 100, and the amounts of squareness deviation 1407 at the same positions A and A′ of the measurement chart are different. The error angle θ is then derived by correcting the amounts of squareness deviation 1407 of the front and back images 1402 and 1404 at each position of the sub scanning direction in opposite directions so that the angles θA and θA′ coincide. Assuming that the coordinates C at the lower left corner of the front image 1402 have a coordinate of “0” in the sub scanning direction, coordinates A2(xp12, yp12) obtained by correcting the amount of squareness deviation 1407 at the coordinates A of the upper left corner in a reverse direction are expressed by the following equations:

yp12=yp2, and (Eq. 2)

xp12=xp1−tan θ×yp12. (Eq. 3)

Using similar equations, reversely-corrected coordinates are also obtained of the coordinates B at the upper right corner and the coordinates C at the lower left corner of the front image 1402, and the coordinates A′ at the upper right corner, the coordinates B′ at the upper left corner, and the coordinates C′ at the lower right corner of the back image 1404. The squareness deviation δ is derived from an angle θ at which the reversely-corrected angles θA and θA′ coincide or approach the closest to each other.

### (Correction of Image Forming Position)

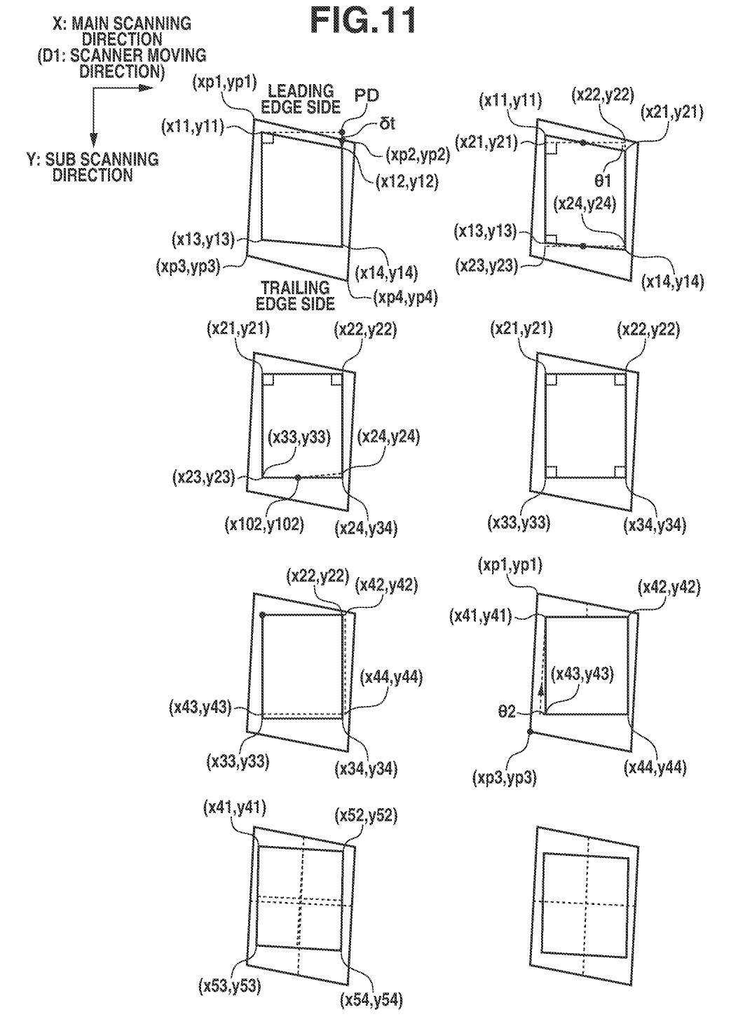

FIG. 11 is an explanatory diagram of processing for correcting an image forming position on a sheet.

The position calculation unit 213 performs edge detection on the image data (read images) obtained by reading the measurement chart by the image scanner 100. The position calculation unit 213 thereby obtains the positions of the sheet ends and the positions of the measurement images 820. The following description deals with the front 802 of the measurement chart. Similar processing is applied to the back 803.

The position calculation unit 213 connects the coordinates (xp1, yp1) of the upper left corner and the coordinates (xp2, yp2) of the upper right corner of the read image of the front 802 of the measurement chart with a line. The position calculation unit 213 connects the coordinates (xp1, yp1) of the upper left corner and the coordinates (xp3, yp3) of the lower left corner of the read image of the front 802 of the measurement chart with a line. The position calculation unit 213 connects the coordinates (xp2, yp2) of the upper right corner and the coordinates (xp4, yp4) of the lower right corner of the read image of the front 802 of the measurement chart with a line. The position calculation unit 213 connects the coordinates (xp3, yp3) of the lower left corner and the coordinates (xp4, yp4) of the lower right corner of the read image of the front 802 of the measurement chart with a line.

The position calculation unit 213 connects coordinates (x11, y11) of the upper left corner of the upper left measurement image 820 and coordinates (x12, y12) of the upper right corner of the upper right measurement image 820 in the read image of the front 802 of the measurement chart with a line. The position calculation unit 213 connects the coordinates (x11, y11) of the upper left corner of the upper left measurement image 820 and coordinates (x13, y13) of the lower left corner of the lower left measurement image 820 in the read image of the front 802 of the measurement chart with a line. The position calculation unit 213 connects the coordinates (x13, y13) of the lower left corner of the lower left measurement image 820 and coordinates (x14, y14) of the lower right corner of the lower right measurement image 820 in the read image of the front 802 of the measurement chart with a line. The position calculation unit 213 connects the coordinates (x12, y12) of the upper right corner of the upper right measurement image 820 and the coordinates (x14, y14) of the lower right corner of the lower right measurement image 820 in the read image of the front 802 of the measurement chart with a line. That the positon calculation unit 213 connects two sets of coordinates with a line refers to deriving an equation of the line passing through the two points.

The position calculation unit 213 determines conversion formula 1 for correcting the image data so that the line connecting the coordinates (x11, y11) and (x12, y12) is orthogonal to the line connecting the coordinates (x11, y11) and (x13, y13). Here, the midpoint of the line connecting the coordinates (x11, y11) and (x12, y12) serves as a reference. Conversion formula 1 is a calculation formula for correcting a write position of an image in the sub scanning direction, i.e., an image forming position at each position of the main scanning direction. A squareness correction amount d, which is the amount of correction to the squareness deviation δ, derived by conversion formula 1 corresponds to a correction condition for the amount of squareness deviation.

The squareness correction amount d is calculated in the following manner. The position calculation unit 213 derives an ideal right angle point PD(xpd, ypd) from the coordinates (x11, y11), (x12, y12), (x13, y13), and (x14, y14). For example, the position calculation unit 213 determines a first line that connects the upper left measurement image 820 and the lower left measurement image 820 in the read image of the front 802 of the measurement chart. The position calculation unit 213 determines a second line that passes through the upper left measurement image 820 in the read image of the front 802 of the measurement chart and crosses the first line at right angles. The position calculation unit 213 determines a third line that connects the lower right measurement image 820 and the upper right measurement image 820 in the read image of the front 802 of the measurement chart. The position calculation unit 213 assumes the intersection of the second and third lines as the ideal right angle point PD. The position calculation unit 213 derives reading squareness δt which is a linear distance from the ideal right angle point PD to the coordinates (x12, y12). Using a gradient a0 of the line connecting the coordinates (x11, y11) and (x13, y13), the ideal right angle point PD(xpd, ypd) is expressed by the following equations:

xpd=x11+(x12−x11), (Eq. 4)

ypd=−xpd/a0+b, and (Eq. 5)

a0=(y11−y13)/(x11−x13), (Eq. 6)

where b is the y intercept of a line that has a gradient of −1/a0 and passes through the coordinates (x11, y11).

The reading squareness δt is the distance between the ideal right angle point PD(xpd, ypd) and the coordinates (x12, y12), and is thus expressed by the following equation:

δt=sqrt((x12−xpd) [symbol] 2+(y12−ypd) [symbol] 2), (Eq. 7)

where the function sqrt( ) is a function for determining a square root. The symbol “ [symbol] ” represents power.

The reading squareness δt is a value including the squareness deviation δ due to individual differences of the image scanner 100. Using the reading squareness δt and the squareness deviation δ due to individual differences, the position calculation unit 213 derives the squareness correction amount d by the following equation:

d=δt+δ (Eq. 8)

The squareness correction amount d, the reading squareness δt, and the squareness deviation δ are index values each indicating a gradient per 1 [mm], and are stored in the scanner individual information storage unit 214 as parameters capable of arithmetic addition. The squareness correction amount d may be stored in the sheet management table 400. The squareness correction amount d corresponds to a first right angle adjustment condition. The squareness deviation δ is a measurement error (reading error) due to individual differences of the image scanner 100. The squareness deviation amount d is a correction condition generated from the result of measurement (read image) of the measurement images 820 by the image scanner 100 to reduce the measurement error (reading error).

The x coordinate of the upper left corner of the read image is corrected by moving the x coordinate along the line (y=a0x+b0) connecting the coordinates (x11, y11) and (x13, y13). The x coordinate of the upper right corner of the read image is corrected by moving the x coordinate along the line (y=a1x+b1) connecting the coordinates (x11, y11) and (x12, y12). If the gradient a1 of the line connecting the coordinates (x11, y11) and (x12, y12) is negative, the coordinates (x11, y11) and (x12, y12) are moved to coordinates (x21, y21) and (x22, y22) by the correction of the reading error of the image scanner 100.

x21=x11−0.5d×cos(θ0) (Eq. 9)

y21=y11−0.5d×sin(θ0) (Eq. 10)

x22=x12+0.5d×cos(θ1) (Eq. 11)

y22=y12+0.5d×sin(θ1) (Eq. 12)

If the gradient a1 of the line connecting the coordinates (x11, y11) and (x12, y12) is positive, the position calculation unit 213 derives the coordinates (x21, y21) and (x22, y22) based on the following equations:

x21=x11+0.5d×cos(θ0), (Eq. 13)

y21=y11+0.5d×sin(θ0), (Eq. 14)

x22=x12−0.5d×cos(θ1), and (Eq. 15)

y22=y12−0.5d×sin(θ1). (Eq. 16)

The reading errors of the image scanner 100 about the coordinates (x11, y11) and (x12, y12) are thereby corrected.

Similarly, the coordinates (x13, y13) of the lower left corner and the coordinates (x14, y14) of the lower right corner of the read image are corrected into coordinates (x23, y23) and (x24, y24), respectively, based on the squareness correction amount d. If the gradient a1 is negative, the following equations are applied:

x23=x13−0.5d×cos(θ0), (Eq. 17)

y23=y13−0.5d×sin(θ0), (Eq. 18)

x24=x14+0.5d×cos(θ1), and (Eq. 19)

y24=y14+0.5d×sin(θ1). (Eq. 20)

If the gradient a1 is positive, the following equations are applied:

x23=x13+0.5d×cos(θ0), (Eq. 21)

y23=y13+0.5d×sin(θ0), (Eq. 22)

x24=x14−0.5d×cos(θ1), and (Eq. 23)

y24=y14−0.5d×sin(θ1). (Eq. 24)

In the foregoing equations, θ0=a tan(a0), and θ1 =a tan(a1).

In such a manner, the effect of the squareness deviation δ inherent to the image scanner 100 on both the read images of the front 802 and the back 803 is reduced. Since the image data is corrected based on the read images corrected by using the squareness deviation δ, the images to be formed on the sheet by the image forming apparatus 10 have correct squareness. In other words, the squareness approaches “0”.

(Eq. 9) to (Eq. 24) are equations for converting the coordinates of the four corners of the read images, whereas conversion formulas for arbitrary points (coordinates) in the read images may be used. A description will be given by using coordinates (x1m, y1m) of an arbitrary point on the line connecting the coordinates (x11, y11) and (x12, y12) as an example. A moving direction resulting from the correction of the arbitrary point is the same as that of the coordinates (x11, y11) or (x12, y12). A moving distance of the arbitrary point is proportional to a distance from the midpoint between the coordinates (x11, y11) and (x12, y12) to the coordinates (x1m, y1m). New coordinates (x2m, y2m) obtained by correcting the coordinates (x1m, y1m) are expressed by the following equations.

If the gradient a1 is negative and the coordinates (x1m, y1m) are closer to the coordinates (x11, y11) than the midpoint is, the new coordinates (x2m, y2m) are expressed by the following equations:

x2m=x1m−0.5d×α×cos(θ0), and (Eq. 25)

y2m=y1m−0.5d×α×sin(θ0). (Eq. 26)

If the gradient a1 is negative and the coordinates (x1m, y1m) are closer to the coordinates (x12, y12) than the midpoint is, the new coordinates (x2m, y2m) are expressed by the following equations:

x2m=x1m+0.5d×α×cos(θ1), and (Eq. 27)

y2m=y1m+0.5d×α×sin(θ1). (Eq. 28)

If the gradient a1 is positive and the coordinates (x1m, y1m) are closer to the coordinates (x11, y11) than the midpoint is, the new coordinates (x2m, y2m) are expressed by (Eq. 27) and (Eq. 28). If the gradient a1 is positive and the coordinates (x1m, y1m) are closer to the coordinates (x12, y12) than the midpoint is, the new coordinates (x2m, y2m) are expressed by (Eq. 25) and (Eq. 26). In the foregoing (Eq. 25) to (Eq. 28), the coefficient α is expressed by the following equation:

α=Lm/L3. (Eq. 29)

“L3” is a distance from the midpoint between the coordinates (x11, y11) and (x12, y12) to the coordinates (x11, y11). “Lm” is a distance from the midpoint between the coordinates (x11, y11) and (x12, y12) to the coordinates (x1m, y1m).

Coordinates (x1n, y1n) of an arbitrary point not lying on the line connecting the coordinates (x11, y11) and (x12, y12) are converted into coordinates (x2n, y2n) by correction. For example, the coordinates (x2n, y2n) are derived by correcting the coordinates (x1n, y1n) in a similar manner to that with the coordinates (x1m, y1m) with reference to an intersection of the line that passes through the midpoint of the coordinates (x11, y11) and (x12, y12) and has the gradient a0 and a line that passes through the coordinates (x1n, y1n) and has the gradient a1.

The position calculation unit 213 determines conversion formula 2 for correcting the image data so that a line connecting the coordinates (x23, y23) and (x24, y24) is orthogonal to a line connecting the coordinates (x21, y21) and (x23, y23). Here, the position (x102, y102) of the midpoint of the line connecting the coordinates (x23, y23) and (x24, y24) serves as a reference. Conversion formula 2 is a calculation formula for correcting the magnification in the sub scanning direction at each point of the main scanning direction. Conversion formula 2 corresponds to a second right angle adjustment condition. Based on conversion formula 2, the position calculate unit 213 corrects the coordinates (x23, y23) into coordinates (x33, y33), and corrects the coordinates (x24, y24) into coordinates (x34, y34).

The position calculation unit 213 determines conversion formula 3 for correcting the image data so that the image to be formed on the sheet has ideal image lengths in the main and sub scanning directions. Here, the upper left corner of the read image serves as a reference. Conversion formula 3 is a calculation formula for correcting the magnifications of the image in the main and sub scanning directions. Conversion formula 3 corresponds to an expansion/contraction adjustment condition. The position calculation unit 213 corrects the coordinates (x21, y21) into coordinates (x41, y41) based on the expansion/contraction adjustment condition. If the upper left corner of the read image serves as a reference, the coordinates (x21, y21) and (x41, y41) have the same values. Based on the expansion/contraction adjustment condition, the position calculation unit 213 corrects the coordinates (x22, y22) into coordinates (x42, y42), the coordinates (x33, y33) into coordinates (x43, y43), and the coordinates (x34, y34) into coordinates (x44, y44).

The position calculation unit 213 corrects the image data so that the left edge of the sheet and the left edge of the image to be formed become parallel. The left edge of the sheet refers to a segment connecting the coordinates (xp1, yp1) at the upper left and the coordinates (xp3, yp3) at the lower left of the measurement chart. The left edge of the image to be formed refers to a segment connecting the coordinates (x41, y41) of the upper left corner and the coordinates (x43, y43) of the lower left corner of the image.

The position calculation unit 213 determines conversion formula 4 for correcting the image data so that the image to be formed on the sheet rotates by an angle of about the upper left corner. Conversion formula 4 corresponds to a rotation adjustment condition. The position calculation unit 213 performs correction based on the rotation adjustment condition, whereby the coordinates (x42, y42) are converted into coordinates (x52, y52), the coordinates (x43, y43) into coordinates (x53, y53), and the coordinates (x44, y44) into coordinates (x54, y54).

If the center position of the sheet deviates from the center position of the image to be formed, the position calculation unit 213 determines conversion formula 5 for correcting the write position in the main and sub scanning directions so that the center positions coincide. For example, the position calculation unit 213 derives the center position of the sheet from the coordinates (xp1, yp1) to (xp4, yp4) of the four corners of the measurement chart. Conversion formula 5 corresponds to an offset condition. The forming position of the image on the sheet, converted based on the offset condition, is the ideal forming position.

As described above, the image itself to be formed on the sheet is shifted by a predetermined amount and rotated based on the lengths from the ends of the sheet to the measurement images 820, whereby the deviation of the image forming position is adjusted. In the manual mode, the position calculation unit 213 determines conversion formulas 1 to 5 for the front 802 based on the information about the front 802, input from the operation unit 20. In the automatic mode, the position calculation unit 213 determines conversion formulas 1 to 5 for the front 802 based on the read image of the front 802 of the measurement chart read by the image scanner 100. Conversion formulas 1 to 5 for the front 802 correspond to the adjustment condition for the first side of the sheet. Conversion formulas 1 to 5 for the front 802 are stored in the sheet management table 400. Conversion formulas 1 to 5 for the front 802 may be integrated into one conversion formula. The image forming position on the back 803 of the sheet is corrected in a similar manner to that with the front 802. In the automatic mode, the position calculation unit 213 determines conversion formulas 1 to 5 for the back 803 based on the read image of the back 803 of the measurement chart read by the image scanner 100. Conversion formulas 1 to 5 for the back 803 correspond to the adjustment condition for the second side of the sheet. Conversion formulas 1 to 5 for the back 803 are stored in the sheet management table 400. At least one of conversion formulas 1 to 5 may be used as an adjustment condition.

If the image forming apparatus 10 forms an image on a sheet based on image data, the position adjustment unit 211 converts the image data based on conversion formulas 1 to 5 stored in the sheet management table 400. A deviation of the image forming position is thereby corrected so that the image forming position with respect to the sheet comes to an ideal position.

### (Generation of Adjustment Condition in Automatic Mode)

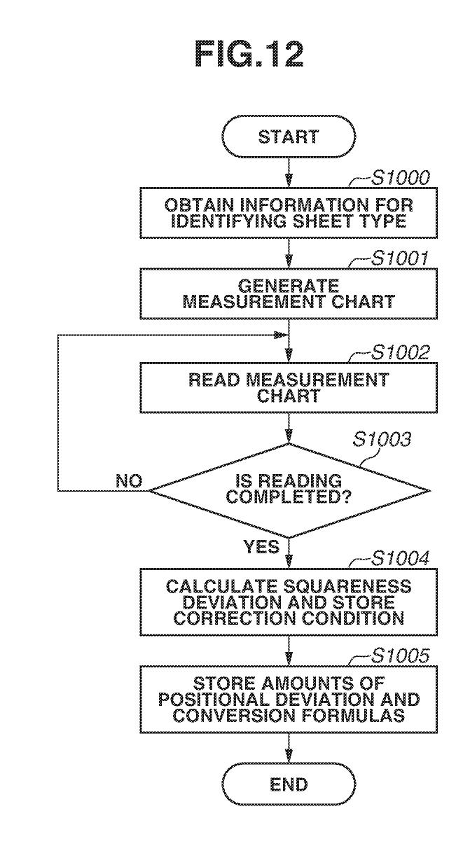

FIG. 12 is a flowchart illustrating processing for generating the adjustment condition in the automatic mode. If a selection instruction for the automatic mode, given from the selection screen 500 of FIG. 3 for selecting the adjustment condition generation mode is obtained from the operation unit 20, the control unit 200 starts the processing for generating the adjustment condition.

In step S1000, the control unit 200 having starting the processing for generating the adjustment condition initially obtains information for identifying a sheet type from the operation unit 20. In step S1001, the control unit 200 obtains the measurement image data for generating a measurement chart for generating the adjustment condition from the pattern generator 70, and makes the printer engine 150 perform image formation processing according to the measurement image data. The measurement chart is thereby generated by forming the measurement images 820 according to the measurement image data on a sheet. The image forming apparatus 10 discharges the generated measurement chart.

In step S1002, the user places the generated measurement chart on the positioning plate of the image scanner 100, and gives an instruction to read the measurement chart from the operation unit 20. The image scanner 100 then reads the measurement chart, and transmits image data expressing the read image to the control unit 200. The measurement chart is read in such a manner.

In step S1003, the control unit 200 determines whether the reading of the measurement chart is completed. For example, if a plurality of measurement charts is generated, the control unit 200 determines whether the reading of the measurement charts is completed, depending on whether image data as much as the number of measurement charts is obtained from the image scanner 100. If the measurement images 820 are formed on both sides of a measurement chart, or sheet, the control unit 200 determines whether the reading of the measurement charts is completed, depending on whether image data twice as much as the number of output measurement charts is obtained. If each side of a measurement chart is read by two separate reading operations, the control unit 200 determines whether the reading of the measurement charts is completed, depending on whether image data four times as much as the number of output measurement charts is obtained.

If the reading of the measurement chart(s) is completed (YES in step S1003), the processing proceeds to step S1004. In step S1004, the control unit 200 calculates a reading error (measurement error) corresponding to individual differences of the image scanner 100 based on the read images expressed by the obtained image data. Here, the control unit 200 calculates the squareness deviation δ. The control unit 200 generates a correction condition for reducing the squareness deviation δ, which is the calculated measurement error, and stores the correction condition into the scanner individual information storage unit 214. The control unit 200 derives a correction condition for reducing the angle of one of the corners of the front image 1402 and the back image 1404 of the read image (see FIG. 10). For example, the control unit 200 derives the correction condition by calculating two angular differences between the front image 1402 and the back image 1404. The control unit 200 may derive the correction condition by estimating error-free images by performing inverse conversion of the measurement error on the front image 1402 and the back image 1404, and calculating a measurement error that minimizes the angles θA and θA′ (see FIG. 10).

The control unit 200 derives the amounts of positional deviation of an image when the image is formed on a sheet, based on the read images of the measurement chart and the derived correction condition. The control unit 200 further derives the foregoing conversion formulas. In step S1005, the control unit 200 stores the derived amounts of positional deviation and the derived conversion formulas as an adjustment condition into the sheet management table 400 corresponding to the sheet for which the correction condition is generated in the processing of step S1004.

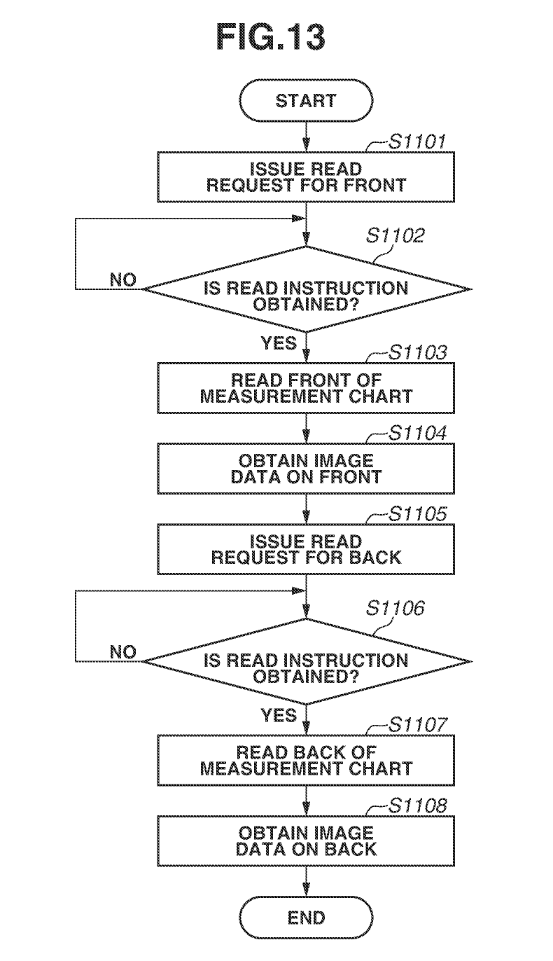

FIG. 13 is a flowchart illustrating processing for reading a measurement chart in step S1002.

In step S1101, after the discharge of the measurement chart, the control unit 200 issues a read request for the front 802 of the measurement chart to the user. For example, the control unit 200 issues the read request by displaying guidance for performing a read operation of the front 802 on the operation unit 20. In step S1102, after the read request, the control unit 200 waits until a read instruction is obtained. According to the guidance, the user places the measurement chart on the positioning plate of the image scanner 100 so that the front 802 is read, and gives an instruction to read the measurement chart from the operation unit 20.

If the read instruction for the measurement chart is obtained from the operation unit 20 (YES in step S1102), the processing proceeds to step S1103. In step S1103, the control unit 200 controls an operation of the image scanner 100 to read the front 802 of the measurement chart. In step S1104, the control unit 200 obtains image data expressing the read image of the front 802 of the measurement chart from the image scanner 100. The image data includes data on the coordinates (x11, y11), (x12, y12), (x13, y13), and (x14, y14) illustrated in FIG. 11. The image data may also include the coordinates (xp1, yp1), (xp2, yp2), (xp3, yp3), and (xp4, yp4) of the four corners of the measurement chart illustrated in FIG. 11. The coordinates of the four corners of the measurement chart are needed in determining the left side and the center position of the measurement chart.

If the reading of the front 802 is finished by the acquisition of the image data expressing the read image of the front 802, then in step S1105, the control unit 200 issues a read request for the back 803 of the measurement chart to the user. For example, the control unit 200 issues the read request by displaying guidance for performing a read operation of the back 803 on the operation unit 20. In step S1106, after the read request, the control unit 200 waits until a read instruction is obtained. According to the guidance, the user places the measurement chart on the positioning plate of the image scanner 100 so that the back 803 is read, and gives an instruction to read the measurement chart from the operation unit 20.

If the read instruction for the measurement chart is obtained from the operation unit 20 (YES in step S1106), the processing proceeds to step S1107. In step S1107, the control unit 200 controls an operation of the image scanner 100 to read the back 803 of the measurement chart. In step S1108, the control unit 200 obtains image data expressing the read image of the back 803 of the measurement chart from the image scanner 100. The image data on the back 803 includes similar contents to the image data on the front 802 (such as the coordinates of the four corners).

The control unit 200 obtains the image data on both sides of the measurement chart by the foregoing processing, and performs the subsequent processing (processing of step S1004 and the subsequent steps).

### (Image Formation Processing)

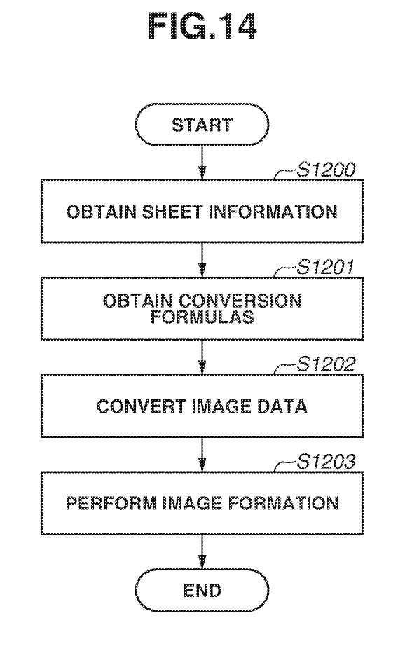

FIG. 14 is a flowchart illustrating image formation processing. The image formation processing includes correction of the image forming positions. In the present exemplary embodiment, processing during normal image formation refers to copy processing in which the image forming apparatus 10 performs image formation on a sheet based on image data on an original image read by the image scanner 100, or processing according to a print job from an external information processing apparatus.

In step S1200, the control unit 200 obtains sheet information about a sheet to be used for image formation, according to an instruction for image formation. The sheet information includes information about the type of the sheet to be used for image formation. The control unit 200 can identify the type of the sheet to be used for image formation from the sheet information.

In step S1201, the control unit 200 obtains conversion formulas, which are the adjustment condition according to the sheet type identified from the sheet information, from the sheet management table 400. As described above, the conversion formulas are equations for suppressing the amounts of positional deviation 518 and 519 of the image forming positions, generated from the measurement chart. In the present exemplary embodiment, the conversion formulas have an improved accuracy since the conversion formulas are derived by correcting the read images of the measurement chart based on the squareness correction amount d.

In step S1202, the control unit 200 converts image data expressing an image to be formed. The control unit 200 obtains the image data to be converted from the image scanner 100. For example, the control unit 200 sets the conversion formulas into the position adjustment unit 211 of the image processing unit 210, and converts the image data by using the position adjustment unit 211. By applying the conversion formulas, the position adjustment unit 211 deforms the shape of the image expressed by the image data beforehand. Such deformation cancels out deformation occurring in the printer engine 150.

In step S1203, the control unit 200 controls the printer engine 150 to perform image formation using the converted image data. An image according to the converted image data is thereby formed on the sheet.

If two-sided printing is instructed, the control unit 200 controls the printer engine 150 to convey the sheet on the front of which the image is formed to the reverse path 113, whereby the sheet is reversed front to back. By processing similar to that of steps S1201 and S1202, the control unit 200 converts image data on the back based on the conversion formulas for the back. The control unit 200 makes the printer engine 150 perform image formation on the back of the sheet by using the converted image data on the back. In such a manner, the images are formed in ideal positions on both sides.

With such a configuration, the image forming apparatus 10 according to the present exemplary embodiment can form images while reducing reading errors of the measurement chart due to the squareness deviation δ inherent to the image scanner 100. More specifically, the reading squareness δt of the measurement chart, occurring due to the image formation processing of the printer engine 150, can be accurately measured. This enables the generation of conversion formulas for more accurately correcting the image forming positions. For example, respective conversion formulas are individually generated for the front and back of a sheet, and the conversion formulas are used to correct image data for two-sided printing. The image forming positions on the front and back of the sheet can thereby be corrected with high accuracy. The squareness of the images is also properly corrected. In other words, the squareness of the front and that of the back both can be brought close to “0”.

The image forming apparatus 10 may be configured to be connected with an external reading device, instead of the image scanner 100. In such a case, the control unit 200 derives the correction condition (squareness correction amount d) based on the read images (reading squareness δt) and individual difference information (squareness deviation δ) of the measurement chart read by the reading device.

A reading device for reading the measurement chart may be built in a sheet conveyance path of the image forming apparatus 10, aside from the image scanner 100. In such a case, the operation in which the user places the measurement chart on the positioning plate of the image scanner 100 and makes the image scanner 100 read the measurement chart is omitted, and the measurement chart is automatically read. This improves usability. The reading device is provided on a sheet conveyance path, downstream of the fixing device 107. For example, the reading device is provided on the conveyance path between the fixing device 107 and the discharge rollers 112, or on the reverse path 113.

If the reading device is provided on the reverse path 113, the control unit 200 conveys the measurement chart on the front 802 of which the measurement images 820 are formed, to the reverse path 113, and makes the reading device read the front 802 of the measurement chart. The control unit 200 then reverses the measurement chart front to back, and conveys the reversed measurement chart to the secondary transfer portion 106. The measurement images 820 are thereby formed on the back 803 of the measurement chart. The control unit 200 conveys the measurement chart on the back 803 of which the measurement images 820 are formed, to the reverse path 113 again, and makes the reading device read the back 803 of the measurement chart. After the back 803 of the measurement chart is read by the reading device, the control unit 200 discharges the measurement chart by using the discharge rollers 112 via the secondary transfer portion 106 and the fixing unit 107.

As is the case when the measurement chart is read by the image scanner 100, the control unit 200 derives the correction condition (squareness correction amount δ) based on the read images (reading squareness δt) and individual difference information (squareness deviation δ) of the measurement chart read by the reading device.

According to the present exemplary embodiment described above, measurement errors (squareness deviation δ) of the read images due to individual differences of the image scanner 100 are derived from the read images of the measurement chart by the position calculation unit 213, and stored in the scanner individual information storage unit 214.

The squareness correction amount d is obtained by adding the squareness deviation δ due to individual differences of the image scanner 100 to the reading squareness δt due to the printer engine 150. The squareness correction amount d is an example of the correction condition generated to reduce the measurement errors (reading errors) from the read images of the measurement chart read by the image scanner 100. The position calculation unit 213 applies the correction condition to the read images of the measurement chart read by the image scanner 100, whereby the measurement errors (reading errors) due to individual differences of the image scanner 100, included in the read images, are reduced. The position calculation unit 213 generates the adjustment condition (the amounts of positional deviation and conversion formulas) according to the read images in which the measurement errors are reduced. The position adjustment unit 211 adjusts the image forming positions on the sheet according to the adjustment condition. Since the effect of individual differences of the image scanner 100 on the read images of the measurement chart on which the measurement images 820 serving as reference images are formed is thus reduced, the correction accuracy of the image forming positions improves.

The image forming apparatus 10 according to the present exemplary embodiment can correct the image forming positions on both sides of a sheet. The image scanner 100 reads the measurement images 820 formed on the front 802 (first side) of the sheet, and reads the measurement images 820 formed on the back 803 (second side) of the sheet. The position calculation unit 213 applies the correction condition to the read image of the measurement images 820 formed on the first side, whereby reading errors (measurement errors) due to individual differences of the image scanner 100 in the read image are reduced. The position calculation unit 213 generates a first adjustment condition for correcting the image forming position on the first side according to the read image of which the reading errors are reduced.

Similarly, the position calculation unit 213 applies the correction condition to the read image of the measurement images 820 formed on the second side, whereby reading errors due to individual differences of the image scanner 100, included in the read image, are reduced. The position calculation unit 213 generates a second adjustment condition for correcting the image forming position on the second side according to the read image of which the reading errors are reduced.

When an image is formed on the first side of a sheet, the position adjustment unit 211 corrects the image forming position according to the first adjustment condition. When an image is formed on the second side of the sheet, the position adjustment unit 211 corrects the image forming position according to the second adjustment condition. The images are thereby formed on both sides of the sheet with the image forming positions accurately corrected.

As described in FIG. 8, the image scanner 100 can obtain an entire read image of the measurement chart by reading the measurement chart in first and second halves by two separate reading operations, and combining the read images. This improves the edge detection accuracy at the sheet ends of the measurement chart, and improves the correction accuracy of the image forming positions.

The position calculation unit 213 generates the adjustment condition in either one of the adjustment condition generation modes, namely, the manual mode or the automatic mode. In the automatic mode, the user does not need to measure the measurement chart for the positions of the measurement images 820. This improves usability. In the manual mode, the reading device such as the image scanner 100 is not needed. In generating the adjustment condition, the effect of individual differences of the image scanner 100 therefore does not need to be taken into consideration.

The measurement chart is generated by forming the measurement images 820 on a sheet as illustrated in FIG. 5. As illustrated in FIG. 11, the position calculation unit 213 generates the adjustment condition based on the positions of the measurement images 820 formed on the measurement chart.

The position calculation unit 213 determines a first line that connects the measurement image 820 formed at the upper left corner and the measurement image 820 formed at the lower left corner of the read image of the measurement chart. The measurement unit 213 determines a second line that passes through the measurement image 820 formed at the upper left corner of the read image of the measurement chart and crosses the first line at right angles. The position calculation unit 213 determines a third line that connects the measurement image 820 formed at the lower right corner and the measurement image 820 formed at the upper right corner of the read image of the measurement chart. The position calculation unit 213 determines the intersection of the second and third lines to be an ideal right angle point PD.

The position calculation unit 213 determines the distance between the ideal right angle point PD and the measurement image 820 formed at the upper right corner of the measurement chart to be the reading squareness δt due to the printer engine 150. The position calculation unit 213 determines the squareness correction amount d by adding the reading squareness δt and the squareness deviation δ which is the reading error due to individual differences of the image scanner 100. The position calculation unit 213 generates the adjustment condition by using the squareness correction amount d.

According to an exemplary embodiment of the present disclosure, the effect of the reading error inherent to the reading unit can be suppressed to improve the accuracy of the image forming positions during image formation.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2016-237702, filed Dec. 7, 2016, which is hereby incorporated by reference herein in its entirety.

What is claimed is:

1. An image forming apparatus comprising:
a reading unit including a carriage configured to move in a predetermined direction and irradiate an original, the reading unit being configured to read the original to generate image data on the original;
an image processing unit configured to perform image processing to the image data based on an adjustment condition for adjusting an image forming position of an image to be formed on a sheet;
an image forming unit configured to form the image on the sheet based on the image data on which the image processing is performed by the image processing unit; and
a controller configured to control the image forming unit to form a first measurement image on a first side of a sheet, control the image forming unit to form a second measurement image on a second side of the sheet, the second side being different from the first side, control the reading unit to obtain reading data related to the sheet on which the first measurement image and the second measurement image are formed, and generate the adjustment condition based on the reading data and a correction condition,
wherein the controller generates the correction condition based on a reading result of the first side of the sheet and a reading result of the second side of the sheet, the first measurement image being formed on the first side, the second measurement image being formed on the second side.

2. The image forming apparatus according to claim 1, wherein the controller generates the correction condition based on a reading result of an edge of the first side of the sheet and a reading result of an edge of the second side of the sheet, the first measurement image being formed on the first side, the second measurement image being formed on the second side.

3. The image forming apparatus according to claim 1, wherein the controller generates the adjustment condition based on first read data related to the first side of the sheet on which the first measurement image is formed, second read data related to the second side of the sheet on which the second measurement image is formed, and the correction condition.

4. The image forming apparatus according to claim 1, wherein the controller generates first data based on first read data related to the first side of the sheet on which the first measurement image is formed and the correction condition, generates second data based on second read data related to the second side of the sheet on which the second measurement image is formed and the correction condition, and generates the adjustment condition based on the first data and the second data.

5. The image forming apparatus according to claim 1, wherein the adjustment condition includes a first adjustment condition for adjusting an image forming position of a first image to be formed on the first side of the sheet, and a second adjustment condition for adjusting an image forming position of a second image to be formed on the second side of the sheet.

6. The image forming apparatus according to claim 5,
wherein the controller generates the first adjustment condition based on first read data related to the first side of the sheet on which the first measurement image is formed and the correction condition, and
wherein the controller generates the second adjustment condition based on second read data related to the second side of the sheet on which the second measurement image is formed and the correction condition.

7. The image forming apparatus according to claim 1, wherein the controller determines an amount of positional deviation of the image forming position due to the image forming unit based on the reading result and the correction condition, and generates the adjustment condition based on the amount of positional deviation.

8. The image forming apparatus according to claim 1, wherein the controller generates the adjustment condition based on the reading data and the correction condition, the adjustment condition being such that a deviation of the image forming position is suppressed.

9. The image forming apparatus according to claim 1, wherein the adjustment condition further includes at least one of a magnification in a sub scanning direction at each position in a main scanning direction, magnifications of the image in the main scanning direction and the sub scanning direction, a rotation adjustment condition, and an offset condition.

10. The image forming apparatus according to claim 1, wherein the adjustment condition includes a conversion formula expressing at least one of the image forming position, a magnification in a sub scanning direction at each position in a main scanning direction, magnifications of the image in the main scanning direction and the sub scanning direction, a rotation adjustment condition, and an offset condition.

11. A method for controlling an image forming apparatus including a reading device including a carriage configured to move in a predetermined direction and irradiate an original, and an image forming unit configured to form an image on a sheet based on image data, the method comprising:
forming a first measurement image on a first side of a sheet;
forming a second measurement image on a second side of the sheet, the second side being different from the first side;
reading the sheet on which the first measurement image and the second measurement image are formed;
generating a correction condition based on a first reading result of the first side of the sheet and a second reading result of the second side of the sheet, the first measurement image being formed on the first side, the second measurement image being formed on the second side;
generating an adjustment condition based on a reading result of the sheet on which the first measurement image and the second measurement image are formed and the correction condition; and
performing image processing on the image data based on the adjustment condition to adjust an image forming position of an image to be formed on a sheet.

12. The method according to claim 11, wherein the correction condition is generated based on a reading result of an edge of the first side of the sheet and a reading result of an edge of the second side of the sheet, the first measurement image being formed on the first side, the second measurement image being formed on the second side.

13. The method according to claim 11, wherein the adjustment condition is generated based on a reading result of the first measurement image, a reading result of the second measurement image, and the correction condition.

14. The method according to claim 11,
wherein first data is generated based on the first reading result of the first side of the sheet, the first measurement image being formed on the first side, and the correction condition,
wherein second data is generated based on the second reading result of the second side of the sheet, the second measurement image being formed on the second side, and the correction condition, and
wherein the adjustment condition is generated based on the first data and the second data.

15. The method according to claim 11, wherein the adjustment condition includes a first adjustment condition for adjusting an image forming position of a first image to be formed on the first side of the sheet, and a second adjustment condition for adjusting an image forming position of a second image to be formed on the second side of the sheet.

16. The method according to claim 15,
wherein the first adjustment condition is generated based on the first reading result of the first side of the sheet and the correction condition, the first measurement image being formed on the first side, and
wherein the second adjustment condition is generated based on the second reading result of the second side of the sheet and the correction condition, the second measurement image being formed on the second side.

17. The method according to claim 11, wherein an amount of positional deviation of the image forming position due to the image forming unit is determined based on the reading result and the correction condition, and the adjustment condition is generated based on the amount of positional deviation.

18. The method according to claim 11, wherein the adjustment condition is generated based on the reading result and the correction condition, the adjustment condition being such that a deviation of the image forming position is suppressed.

19. The method according to claim 11, wherein the adjustment condition further includes at least one of a magnification in a sub scanning direction at each position in a main scanning direction, magnifications of the image in the main scanning direction and the sub scanning direction, a rotation adjustment condition, and an offset condition.

20. The method according to claim 11, wherein the adjustment condition includes a conversion formula expressing at least one of the image forming position, a magnification in a sub scanning direction at each position in a main scanning direction, magnifications of the image in the main scanning direction and the sub scanning direction, a rotation adjustment condition, and an offset condition.
